(19) United States
(12) Patent Application Publication
(10) Pub. No.: US 2005/0011709 A1
(43) Pub. Date: Jan. 20, 2005

(54) Dynamic vibration reduction system

(76) Inventors: Chih-Hsuan Yang, Hsinchu (TW); Cheng-Yang Hsieh, Hsinchu (TW); Chen-Yuan Huang, Hsinchu (TW); Chi-Shen Chang, Hsinchu (TW)

Correspondence Address: BIRCH STEWART KOLASCH & BIRCH, PO BOX 747, FALLS CHURCH, VA, 22040-0747, US

(21) Appl. No.: 10/725,468

(22) Filed: Dec. 3, 2003

(30) Foreign Application Priority Data
Jul. 15, 2003 (TW) 092119286

(51) Int. Cl. F16F 15/03

(52) U.S. Cl. 188/267

(57) ABSTRACT

A dynamic vibration reduction system, applicable in an electronic product, includes a main buffering unit, an auxiliary buffering unit, and a driving module. The main buffering unit is connected to a carrier of the electronic product to reduce vibrations of the carrier. The auxiliary buffering unit is movably mounted on one side of the carrier. The driving module is assembled in the auxiliary buffering unit to either abut the auxiliary buffering unit against the carrier and reduce the vibration of the carrier, or space the auxiliary buffering unit away from the carrier at a predetermined distance. The vibration reduction of a system is variable with the control of the connection between the auxiliary buffering unit and the carrier to maximize the performance of the electronic product.

### BACKGROUND OF THE INVENTION

1. Field of Invention

The present invention relates to a vibration proof system, and more particularly to a dynamic vibration reduction system that enables dynamic vibration adjustment of an operation system.

2. Related Art

As the electronic technology rapidly progresses, electronic products such as digital cameras, laptops, desktop computers, scanners, hard disks and CD-ROM drives, provide increasingly high performance at lower prices. For example, the reading speed and capacity of the CD-ROM drive have been dramatically increased in the past years, upgrading the CD-ROM drive from one single function to multi-functions to presently become a widely used multi-medium storage device. Meanwhile, as the storage medium has evolved from the compact disk (CD) to the high-capacity digital versatile disk (DVD), the CD-ROM drive has evolved from an in-site operation platform to a portable multi-medium center.

A portable electronic product such as a portable and detachable CD-ROM drive must have a hard vibration system in order to effectively withstand external impact, as disclosed in U.S. Pat. No. 5,668,791. In addition to a damper usually employed in the prior art, a spring is further mounted to increase vibration reduction of the operation system. However, this increases a resonance frequency of the operation system, although it reasonably increases the buffering effect and reduces the amount of vibration shifts. Increasing the resonance frequency of the operation system greatly influences the access of the electronic product such as the CD-ROM drive, which is disadvantageous to an in-site electronic product with high access speed and high capacity.

An approach to solve the above problem is disclosed in U.S. Pat. No. 5,332,203. Vibration reduction of the electronic product in operation is automatically controlled via the servo-control of the damper. A sensor detects the external impact that is conveyed to the operation system and informs a control system. The control system outputs a reverse signal to an electronic control element such as an electromagnetic valve or motor to modify the vibration reduction of the electronic product in operation, via a transmission device.

Although this provides real-time compensation of the vibration, the complex configuration and the high cost of the components, as well as their complex control loop, cannot allow a wide application of electronic products. The same problems are also found in U.S. Pat. No. 5,427,362.

Therefore, a vibration reduction system can solve the above problems.

### SUMMARY OF THE INVENTION

It is therefore an object of the invention to provide a dynamic vibration reduction system that dynamically adjusts vibration reduction of an operation system according the situation of use.

An electronic product (such as CD-ROM drive or a hard disk) that is mounted on a carrier includes a main driving motor. The dynamic vibration reduction system of the invention effectively reduces the vibration generated from the operation of the electronic product in two ways.

A conventional in-site electronic product requires stable operation in a proper location at high access speed. In a conventional in-site electronic product, the vibration reduction system is soft. Instead, a portable electronic product often subjected to unexpected external forces cannot be provided with high capacity and high access speed. In such an electronic product, a hard vibration reduction system is required.

The ways to effectively reduce vibration generated from the operation of the electronic product according to the invention include a high access mode and an access under vibration mode. In the high access mode, the electronic product operates at high access speed, and the main buffering unit mainly provides a dynamic vibration reduction function. When the electronic product is carried out, the electronic product is set to the access under vibration mode. The dynamic vibration reduction system of the invention includes an auxiliary buffering unit, in addition to the main buffering, to abut the electronic product against the carrier to further provide vibration reduction for the electronic product, when the electronic product is subjected to an external force.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and is thus not limitative of the present invention, and wherein:

FIG. 1A and FIG. 1B are schematic views of a dynamic vibration reduction system according to one embodiment of the invention;

FIG. 2A and FIG. 2B are schematic views of a dynamic vibration reduction system according to another embodiment of the invention;

FIG. 3 is an exploded view of a dynamic vibration reduction system according to one embodiment of the invention;

FIG. 4 is an assembled view of a dynamic vibration reduction system according to one embodiment of the invention; and

FIG. 5 is a schematic view of the operation of a dynamic vibration reduction system according to one embodiment of the invention.

### DETAILED DESCRIPTION OF THE INVENTION

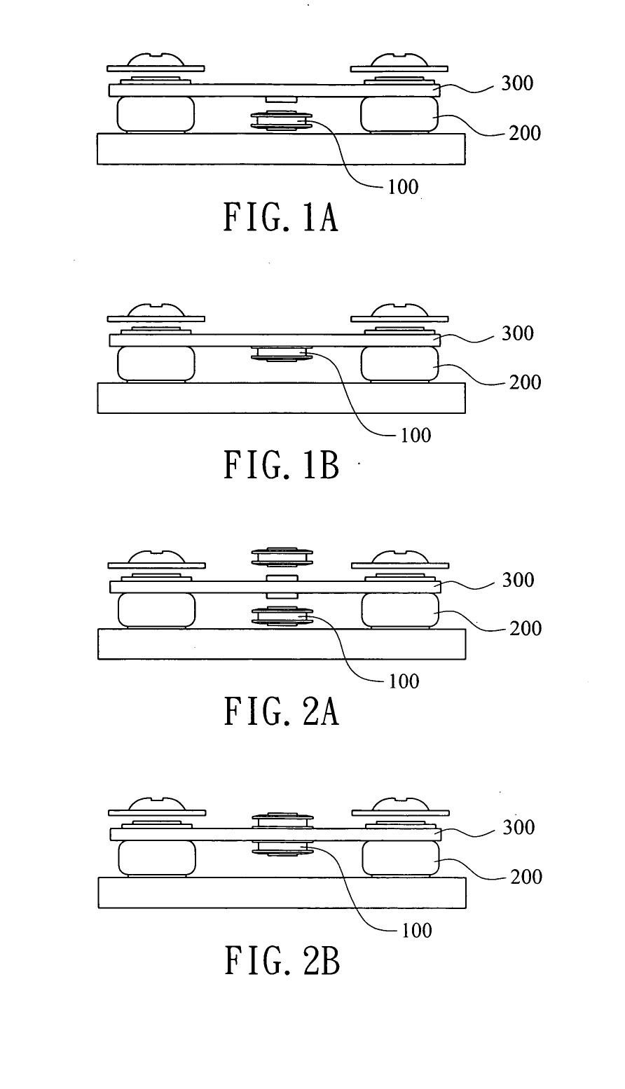

FIG. 1A illustrates a dynamic vibration reduction system according to one embodiment of the invention. A carrier 300 is used to support a main driver motor or other electronic devices (not shown). The carrier 300 is mounted with a main buffering unit 200. The main buffering unit 200 is an elastic element such as a spring or a damper to provide vibration reduction effect, as those used in conventional DVD players. An auxiliary buffering unit 210 is movably mounted on a bottom of the carrier 300. The auxiliary buffering unit 210 can be an elastic element, such as a spring or a damper, the same as the main buffering unit 210. In FIG. 1A, the main buffering unit is responsible for the vibration reduction, which is suitably used in an in-site electronic product that operates high-speed in a stable environment, free from any interference of an external force.

Referring to FIG. 1B, the auxiliary buffering unit 210 abuts against the carrier 300 due to the action of force to further reduce vibrations of the system. Therefore, the system equipped with the main and auxiliary buffering units 200, 210 is effectively prevented from being externally impacted, and thus is suitably portable.

Furthermore, the number of auxiliary buffering units 210 is not particularly limited to one. For example, auxiliary buffering units 200 are mounted on either side of the carrier 300 as shown in FIG. 2A and FIG. 2B. The main buffering unit 200 is mounted on the carrier 300. The main buffering unit 200 is an elastic element such as a spring or a damper to provide vibration reduction effects. The auxiliary buffering unit 210 is movably mounted on a bottom of the carrier 300. The auxiliary buffering unit 210 can be the same elastic element as the main buffering unit 210, such as a spring or a damper. When the system operates at high speed, the auxiliary buffering unit 210 is not in action. When the system tends to be impacted by external force during transport, the auxiliary buffering unit 210 abuts against the carrier 300 to further reduce the vibrations of the carrier 300, as shown in FIG. 2B.

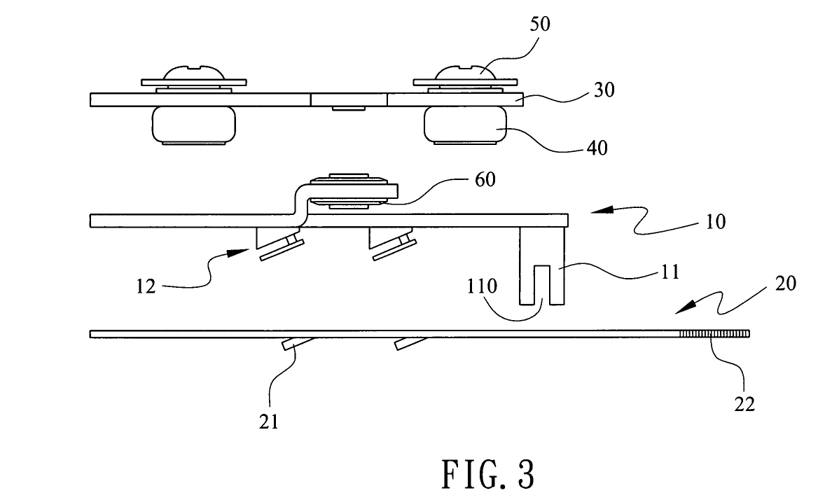

FIG. 3 is an exploded view of a dynamic vibration reduction system according to one embodiment of the invention. The carrier 30 is mounted inside an electronic device to support the main driver motor and other electronic devices (not shown). A main buffering unit 40 is mounted on the carrier 30 via a plurality of fastening screws 50. The main buffering unit 40 can be an elastic element, such as a spring or a damper to provide a vibration reduce effect. An auxiliary buffering unit 60 is mounted on a passively moving body 10. The auxiliary buffering unit 60 can be the same elastic element as the main buffering unit 40, such as a spring or a damper. At least one retaining part, such as a grooved slant block 12 as shown in FIG. 3, is further formed on the bottom of the passively moving body 10. A positioning arm 11 straightly extends downward from the bottom of the passively moving body 10. The positioning arm 11 further forms a slot 110. At least one standoff, such as a slant protrusion 21 as illustrated, is formed on an actively moving body 20 to correspond to the retaining part of the passively moving body 10. An engaging portion, including a plurality of teeth, is formed at one end of the actively moving body 20.

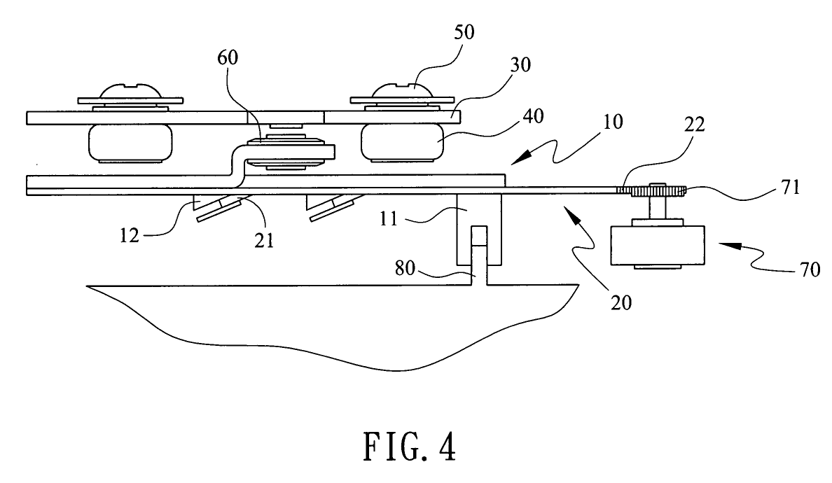

The mutual movement between components of the system is detailed as follows. Referring to FIG. 4, the passively moving body 10, equipped with the auxiliary buffering unit 60 is mounted on a bottom of the carrier 30. A positioning protuberance 80 is formed on a casing of the electronic device to correspond to the slot 110 of the positioning arm 11, so that the positioning protuberance 80 engages with the slot 110. The actively moving body 20 is mounted on the bottom of the passively moving body 10. The slant protrusion 21 on the bottom of the actively moving body 20 slidably moves into the grooved slant block 12. A driver motor 70 is mounted near the engaging portion 22 of the actively moving body 20. The driver motor 70 has a driving gear 71 at its shaft. The auxiliary buffering unit 60 is spaced from the carrier 30 at a predetermined distance. The main buffering unit 40 provides the vibration reduction, which is suitable for use in the in-site electronic product that operates at high speed.

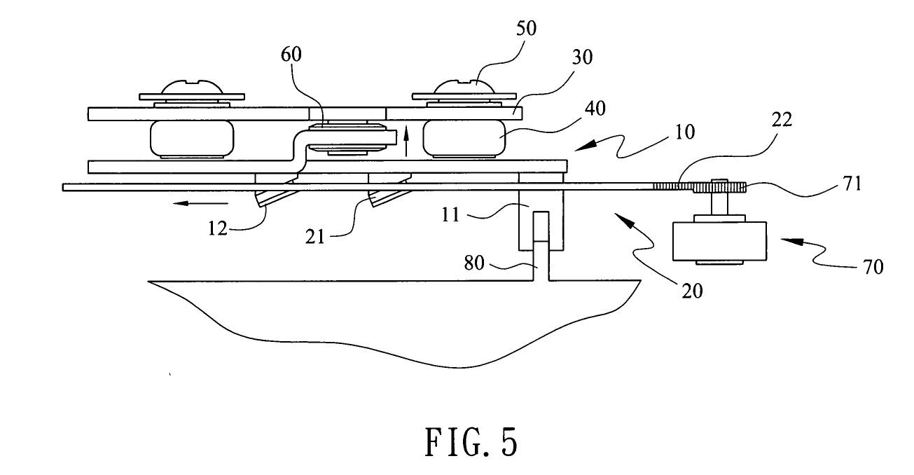

Referring to FIG. 5, when the electronic device is to be carried, the auxiliary buffering unit 60 is required to further reduce extra-vibrations, in conjunction with the main buffering unit 40. When the driver motor 70 operates, the driving gear 71 engages with the teeth of the engaging portion 22 to drive the actively moving body 20 and shift it to the left for a predetermined distance. At this time, the slant protrusion 21 of the actively moving body 20 inserts in the grooved slant block 12 to move left of the actively moving body 20. With the arrangement of the positioning arm 11 of the actively moving body 20 and the positioning protuberance 80, the actively moving body 20 is not allowed to move to the left anymore; instead, the actively moving body 20 is forced to shift upwardly. With the mutual movement between the slant protrusion 21 and the grooved slant block 12, the auxiliary buffering unit 60 is raised a predetermined height to abut against the carrier 30, providing further vibration reductions. In other words, power from the driver motor 70 is used to adjust the relative position between the auxiliary buffering unit 60 and the carrier 30 to achieve dynamic buffering of the system. In a variant example, the auxiliary buffering unit 60 can be as shown in FIG. 2A and FIG. 2B. In this case, the auxiliary buffering units 60 are respectively mounted on two sides of the carrier 30 and operate in the manner shown in FIG. 5 to provide good vibration buffering by separating the auxiliary buffering units 60 from the carrier 30 and abutting the auxiliary buffering units 60 against the carrier 30.

As described above, the invention provides the following advantages:

1. Dynamic Adjustment of Vibration Reduction

The conventional vibration reduction system provides simple vibration reduction. Once the conventional vibration reduction system is assembled, the system operates at a constant resonance frequency. In contrast, the dynamic vibration reduction system of the invention dynamically adjusts the vibration tolerance according to the situation of use. Specifically, the dynamic vibration reduction system provides suitable vibration reduction effects, regardless that the electronic product is used in-site or carried out.

2. Easy Control

The vibration reduction of the system is dynamically controlled with the control of the connection between the auxiliary buffering unit and the carrier. Furthermore, the assembly space required for the dynamic vibration reduction system is advantageously reduced, which makes it particularly suitable for electronic devices such as DVD drives or Hard disks.

3. Low Cost

The dynamic vibration reduction system has a configuration simpler than the complex control mechanisms of the prior art used to vary the vibration tolerance of the system. The method of driving the dynamic vibration reduction system of the invention is easy, but other variant embodiments can be envisaged to drive the dynamic vibration reduction system, which significantly reduces the production costs and greatly increases the compatibility thereof.

Knowing the invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A dynamic vibration reduction system, applicable in an electronic product, the electronic device including a carrier to support an electronic device, the dynamic vibration reduction system comprising:
a main buffering unit, connected to the carrier to reduce vibrations of the carrier;
an auxiliary buffering unit, movably mounted on one side of the carrier; and
a driving module, assembled in the auxiliary buffering unit to either abut the auxiliary buffering unit against the carrier to reduce vibrations of the carrier, or spacing the auxiliary buffering unit away from the carrier at a predetermined distance.

2. The dynamic vibration reduction system of claim 1, wherein the main buffering unit is an elastic element.

3. The dynamic vibration reduction system of claim 2, wherein the elastic element is a spring.

4. The dynamic vibration reduction system of claim 1, wherein the main buffering unit is a damper.

5. The dynamic vibration reduction system of claim 1, wherein the auxiliary buffering unit is an elastic element.

6. The dynamic vibration reduction system of claim 5, wherein the elastic element is a spring.

7. The dynamic vibration reduction system of claim 1, wherein the auxiliary buffering unit is a damper.

8. The dynamic vibration reduction system of claim 1, wherein the driving module further comprises:
a passively moving body, mounted on a bottom of the carrier to support the auxiliary buffering unit, wherein a retaining part is formed on a bottom of the passively moving body;
an actively moving body, mounted on a bottom of the passively moving body, wherein a standoff is formed on the actively moving body to correspond to the retaining part of the passively moving body, and an engaging portion is formed at one end of the actively moving body; and
a driving motor, connected to an the engaging portion and mounted on one side of the passively moving body, wherein when the driver motor operates, the actively moving body moves toward a predetermined direction, so as to driving gear engages with the teeth of the engaging portion to drive the actively moving body, so that the passively moving body is raised at a predetermined distance with the mutual action of the retaining portion and the standoff to drive the auxiliary buffering unit to engage with the carrier.

9. The dynamic vibration reduction system of claim 8, wherein the retaining part is a grooved slant block.

10. The dynamic vibration reduction system of claim 9, wherein the grooved slant block is formed on the bottom of the passively moving body.

11. The dynamic vibration reduction system of claim 8, wherein the standoff is a slant protrusion.

12. The dynamic vibration reduction system of claim 11, wherein the slant protrusion is formed on the bottom of the passively moving body.

13. The dynamic vibration reduction system of claim 8, wherein the engaging portion has a plurality of teeth.

14. The dynamic vibration reduction system of claim 13, wherein the driver motor has a driving gear to engage with the teeth of the engaging portion.

15. The dynamic vibration reduction system of claim 8, wherein a positioning arm is further formed to straightly extend downward from the bottom of the passively moving body.

16. The dynamic vibration reduction system of claim 15, further comprising a positioning protuberance on the electronic product to limit the moving range of the actively moving body.

17. The dynamic vibration reduction system of claim 15, wherein the positioning arm has a slot to engage with the positioning protuberance.

18. A dynamic vibration reduction system, applicable in an electronic product, the electronic device including a carrier to support an electronic device, the dynamic vibration reduction system comprising:
a main buffering unit, connected to the carrier to reduce vibrations of the carrier;
two auxiliary buffering unit, movably mounted on two sides of the carrier; and
a driving module, assembled in the auxiliary buffering unit to either abut the auxiliary buffering unit against the carrier to reduce vibrations of the carrier, or spacing the auxiliary buffering unit away from the carrier at a predetermined distance.

19. The dynamic vibration reduction system of claim 18, wherein the main buffering unit is an elastic element.

20. The dynamic vibration reduction system of claim 19, wherein the elastic element is a spring.

21. The dynamic vibration reduction system of claim 18, wherein the main buffering unit is a damper.

22. The dynamic vibration reduction system of claim 18, wherein the auxiliary buffering unit is an elastic element.

23. The dynamic vibration reduction system of claim 22, wherein the elastic element is a spring.

24. The dynamic vibration reduction system of claim 18, wherein the auxiliary buffering unit is a damper.
